(19) United States
(12) Patent Application Publication
(10) Pub. No.: US 2016/0243664 A1
(43) Pub. Date: Aug. 25, 2016

(54) MACHINE TOOL

(71) Applicant: FANUC Corporation, Yamanashi (JP)

(72) Inventor: Daisuke NAGATA, Yamanashi (JP)

(21) Appl. No.: 15/046,450

(22) Filed: Feb. 18, 2016

(30) Foreign Application Priority Data
Feb. 19, 2015 (JP) 2015-30691

(51) Int. Cl. B23Q 17/24; G05B 19/19

(52) U.S. Cl. CPC B23Q 17/2471; G05B 19/19; G05B 2219/45151

(57) ABSTRACT

A machine tool for deburring a burred workpiece obtains shape data on the workpiece by capturing an image of the workpiece by means of a visual sensor and compares shape data on the workpiece with previously stored shape data on a deburred workpiece, thereby calculating burr data including the width, depth and position of a burr. A machining path for deburring the workpiece is generated based on the calculated burr data.

### BACKGROUND OF THE INVENTION

1. Field of the Invention

The present invention relates to a machine tool, and more particularly, to a machine tool for controlling a machining path for deburring casting workpieces.

2. Description of the Related Art

In deburring casting workpieces by means of a machine tool, a program is created based on a reference workpiece bearing the largest number of burrs or with passes increased by one, since each casting is formed with burrs that vary in size by millimeters. If this is done, machining of those workpieces which are formed with fewer burrs than the reference workpiece involves a lot of air cuts (idling motions), resulting in a waste of time.

Japanese Patent Applications Laid-Open Nos. 2007-021634, 07-104829, and 07-121222 disclose, as conventional technologies for deburring, techniques in which a machining path is generated according to visual sensor data and a robot is used for automated deburring.

In the techniques disclosed in Japanese Patent Applications Laid-Open Nos. 2007-021634 and 07-121222, however, the robot can hold only a small tool and the torque with which the robot can withstand machining is low. Therefore, machining conditions for heavily burred portions should be lowered, resulting in a problem that the machining time is inevitably long. Depending on the size of burrs, moreover, machining or deburring may be impracticable.

Although a tool and machining conditions can be selected depending on the size of burrs according to the technique disclosed in Japanese Patent Application Laid-Open No. 07-104829, moreover, it is necessary to use a tool having a diameter larger than the varying burr size. If a large tool is used, machining load becomes so high that it is necessary to reduce the feed speed. Since the machining load bearable by the robot is considerably smaller than that by a machine tool, moreover, there is a problem that machining time is increased or machining is impracticable.

### SUMMARY OF THE INVENTION

Accordingly, an object of the present invention is to provide a machine tool capable of confirming the formation of burrs by means of a visual sensor, selecting an optimal tool for machining the burrs, and selecting an optimal number of times of cutting to generate a machining path.

A machine tool according to the present invention is used for deburring a burred unmachined workpiece, and include: at least one visual sensor configured to capture an image of the unmachined workpiece; an unmachined workpiece shape data storage unit configured to store shape data on the unmachined workpiece shot by the visual sensor; a machined workpiece shape data recording unit stored with shape data on a machined workpiece; a tool data storage unit configured to store the shape and cutting conditions of a tool; a burr data calculation unit configured to compare the shape data on the machined workpiece stored in the machined workpiece shape data recording unit and the shape data on the unmachined workpiece stored in the unmachined workpiece shape data storage unit and calculate burr data including the width, depth and position of a burr; and a machining path generation unit configured to generate a machining path along which the burr is removed based on the burr data calculated by the burr data calculation unit.

The machine tool may further comprise tool selection unit configured to select a tool to be used for deburring depending on the size of the burr calculated by the burr data calculation unit, and the machining path generation unit can generate the machining path by calculating the number of times of cutting for machining based on the size of the burr calculated by the burr data calculation unit and a maximum cutting depth in selected tool data.

Images of the workpiece may be captured by the visual sensor from two or more directions. In this case, the machine tool may comprise a plurality of the visual sensors capable of capturing the images of the workpiece from the two or more directions by individually shooting the workpiece from different directions. Alternatively, the visual sensor may be mounted on a robot such that the images of the workpiece are captured from the two or more directions by changing the posture of the robot.

According to the present invention, there can be provided a machine tool capable of confirming the formation of burrs by means of a visual sensor, selecting an optimal tool for machining the burrs, and selecting an optimal number of times of cutting to generate a machining path. Since programs are automatically created, the difficulty in programming, which has been an obstacle to the market penetration of automated deburring, can be removed. Since an optimal machining program can be created, moreover, there is an effect that the machining time can be reduced to increase productivity.

### BRIEF DESCRIPTION OF THE DRAWINGS

The above and other objects and features of the present invention will be obvious from the ensuing description of embodiments with reference to the accompanying drawings, in which:

FIG. 1 is a view illustrating a first embodiment of a machine tool according to the present invention, configured to capture a workpiece shape by means of two or more visual sensors;

FIG. 2 is a view illustrating a second embodiment of the machine tool according to the present invention, configured to capture a workpiece shape by means of a visual sensor mounted on a robot;

FIG. 3 is a flowchart illustrating processing for deburring by means of the machine tool according to the present invention;

FIGS. 4A and 4B are views showing a deburred workpiece to illustrate a first operation example for deburring;

FIGS. 5A and 5B are views showing a burred workpiece to illustrate the first operation example for deburring;

FIGS. 6A and 6B are views illustrating processing for generating a machining path for deburring the workpiece shown in FIGS. 5A and 5B;

FIGS. 7A and 7B are views showing a deburred workpiece to illustrate a second operation example for deburring;

FIGS. 8A and 8B are views showing a burred workpiece to illustrate the second operation example for deburring;

FIGS. 9A and 9B are views illustrating processing for generating a machining path for deburring the workpiece shown in FIGS. 8A and 8B;

FIGS. 10A and 10B are views showing a burred workpiece to illustrate a third operation example for deburring;

FIG. 11 is a view illustrating processing for generating a machining path for deburring the workpiece shown in FIGS. 10A and 10B; and

FIG. 12 is a block diagram showing components constituting a machine tool according to the present invention.

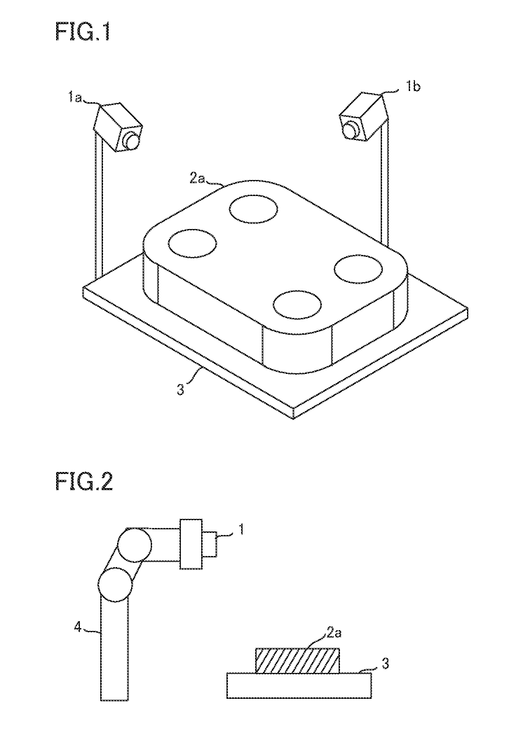

### DETAILED DESCRIPTION OF THE PREFERRED EMBODIMENTS

In workpiece deburring, according to the present invention, a three-dimensional model shape of a workpiece to be deburred is captured, and the formation of burrs is analyzed by comparing the captured three-dimensional model shape with previously registered product data. A tool is selected based on the shape of the workpiece and the analyzed formation of burrs, a machining path is generated based on the selected tool, and deburring is performed.

The following is a description of function means that constitutes a machine tool according to the present invention.

### Acquisition Means for Formation of Burrs on Workpiece

In starting workpiece deburring, it is necessary to confirm the formation of burrs. In the present invention, a finished workpiece 2a which has already been deburred is set on a machining jig 3 in the machine tool, and shape data on the finished workpiece 2a is obtained by capturing images of the workpiece 2a from two or more directions by visual sensors 1a and 1b, such as cameras, as shown in FIG. 1. The obtained shape data is recorded in advance in a machined workpiece shape data storage area on a memory provided to the machine tool. To achieve the image capture from two or more directions, the two or more visual sensors 1 may be used to capture the images, as shown in FIG. 1, or a single visual sensor 1 mounted on a robot 4 may be used to capture the images at a plurality of angles by controlling a robot arm. Further, shape measurement sensors may be used in place of the cameras.

In confirming the formation of burrs, an unmachined workpiece yet to be deburred is set on the machining jig 3 in the machine tool, and shape data on the unmachined workpiece is obtained by capturing images of the workpiece by visual sensors 1, such as cameras, in the same manner as aforementioned. The obtained shape data is recorded in an unmachined workpiece shape data storage area on the memory provided to the machine tool.

The shape data on the unmachined workpiece stored in the unmachined workpiece shape data storage area and the shape data on the finished workpiece stored in the machined workpiece shape data storage area are compared with each other to obtain a shape error between both the shape data, and it is determined whether or not the obtained shape error is covered by error data previously set in a measurement error storage area on the memory provided to the machine tool. If the shape error is covered by the error data, it is determined that there is no formation of burrs. If the shape error is not covered, in contrast, it is determined that a burr or burrs are formed.

If it is determined that the workpiece is burred, as described above, data indicative of the position, width, and depth of a burr or burrs on the unmachined workpiece are output, and these output data are stored into a burr data storage area on the memory provided to the machine tool.

If burrs are formed at a plurality of positions, data, such as burr data 1 and burr data 2, are separately stored for each position of formation of the burrs.

### Tool Selection Means

If it can be confirmed that a burr is formed on the workpiece, it is necessary to select an appropriate tool for removing the formed burr before starting deburring. In the present invention, the appropriate tool for deburring is selected based on burr data indicative of the width, depth, position, etc., of the burr and the shape of the unmachined workpiece.

In the present invention, tool data (including a tool diameter, tool length, and cutting conditions) for each of a plurality of tools used for deburring are stored in advance in a tool data storage area on the memory provided to the machine tool. The cutting conditions are parameters including a spindle speed, feed speed, cutting width, cutting depth, etc. In tool selection, an appropriate tool is selected from the tool data stored in the tool data storage area, in consideration of the shape of the unmachined workpiece, based on the burr data, including the width, depth, and position of the burr, stored in the burr data storage area or as required.

In a possible example of a tool selection method, tools having diameters that enable efficient burr machining (e.g., large-diameter tools each capable of simultaneously machining a predetermined number of burrs or more) are extracted from the tool data stored in the tool data storage area, based on the burr position in the burr data recorded in the burr data storage area, and a tool having the smallest diameter (tool less loaded during machining) is selected from the extracted tools.

In another possible example of the tool selection method, moreover, tools having diameters that enable efficient burr machining without interfering with the unmachined workpiece (e.g., large-diameter tools each capable of simultaneously machining a predetermined number of burrs or more) are extracted from the tool data stored in the tool data storage area, based on the burr position in the burr data recorded in the burr data storage area and the shape of the unmachined workpiece, and a tool having the smallest diameter (tool less loaded during machining) is selected from the extracted tools.

In still another possible example of the tool selection method, tools having diameters that enable burr machining without interfering with the unmachined workpiece are extracted from the tool data stored in the tool data storage area, based on the burr position in the burr data recorded in the burr data storage area and the shape of the unmachined workpiece, a load generated during machining is calculated based on the cutting conditions of the extracted tool and the width and depth of the burr in the burr data, and a tool having a maximum diameter such that the calculated load is not higher than a predetermined value is selected.

### Machining Path Generating Means

After the tool used for deburring is selected, a machining path for deburring by the selected tool is generated.

The machining path for deburring can be generated by performing a conventional machining simulation based on the position, length, etc., of the burr. In addition, in generating the machining path according to the present invention, (1) the burr width in the burr data stored in the burr data storage area and a maximum cutting width in selected tool data are compared with each other and the number of times the workpiece is to be cut along the tool diameter is calculated, and (2) the burr depth in the burr data stored in the burr data storage area and a maximum cutting depth in the selected tool data are compared with each other and the number of times the workpiece is to be cut in the direction of the tool depth is calculated. The number of times of cutting along the tool diameter and the number of times of cutting in the direction of the tool depth, calculated in (1) and (2), respectively, are combined to generate the machining path.

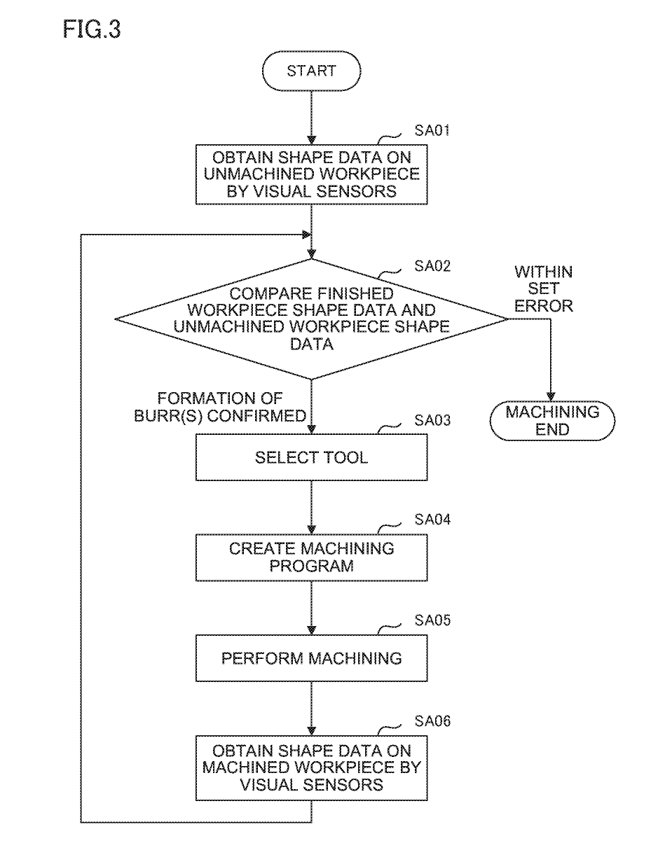

Processing for deburring by means of the machine tool of the present invention will be described with reference to the flowchart of FIG. 3.
[Step SA01] The shape data on the unmachined workpiece is obtained by the visual sensors and recorded in the unmachined workpiece shape data storage area.
[Step SA02] The finished workpiece shape data recorded in the machined workpiece shape data storage area and the unmachined workpiece shape data recorded in the unmachined workpiece shape data storage area are compared with each other to calculate a shape error, and it is determined whether or not the calculated shape error exceeds the range of preset error data. If the range of the error data is exceeded, it is determined that the workpiece is burred, whereupon the processing proceeds to Step SA03. If the calculated shape error is covered by the error data, this processing ends.
[Step SA03] The burr data is created based on the shape error calculated in Step SA03, and an optimal tool is selected based on the burr data.
[Step SA04] The machining path is generated based on the tool selected in Step SA03, the created burr data, and the shape of the unmachined workpiece, and a machining program is created based on the machining path.
[Step SA05] The unmachined workpiece is deburred in accordance with the machining program created in Step SA04.
[Step SA06] The shape data on the workpiece deburred in Step SA05 is obtained by the visual sensors and recorded in the unmachined workpiece shape data storage area, whereupon the processing returns to Step SA02.

The following is a description of some examples of operation of tool selection means and machining path generation means during deburring.

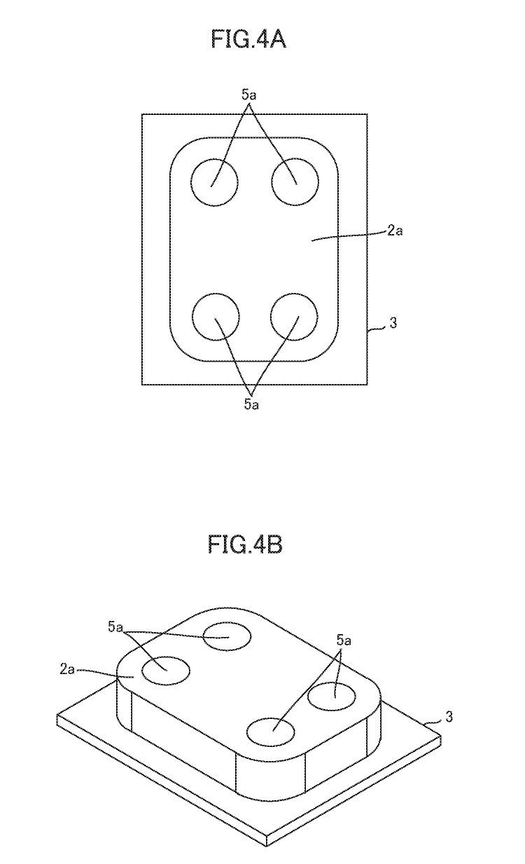

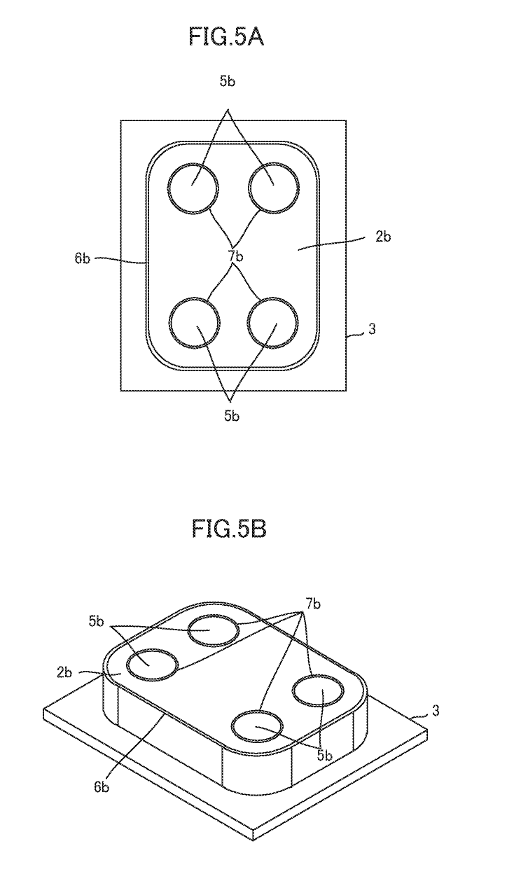

A first example of operation of the tool selection means and the machining path generation means during deburring will first be described with reference to FIGS. 4A and 4B, which show a deburred workpiece (finished workpiece), and FIGS. 5A and 5B, which show a burred workpiece (workpiece to be deburred).

As shown in the plan view of FIG. 4A and the perspective view of FIG. 4B, the finished workpiece 2a has a shape obtained by rounding the four corners of a box with a rectangular cross-section and is provided with four vertically penetrating holes 5a.

If a workpiece having such a shape is machined from a material, burrs may sometimes be formed on angled portions such as the edges of the workpiece, edges of the holes, and the like. FIGS. 5A and 5B show how burrs 6b and 7b are formed on the edges of an unmachined workpiece (workpiece to be deburred) 2b and the edges of holes 5b, respectively. All these burrs 6b and 7b are assumed to extend upward as in FIG. 5B.

In deburring the unmachined workpiece 2b shown in FIGS. 5A and 5B by means of the machine tool according to the present invention, shape data on the unmachined workpiece 2b is obtained by visual sensors (not shown). The obtained shape data and the shape data on the finished workpiece 2a stored in advance in the machined workpiece shape data storage area are compared with each other, and burr data on the burrs 6b and 7b are created individually and recorded in the burr data storage area.

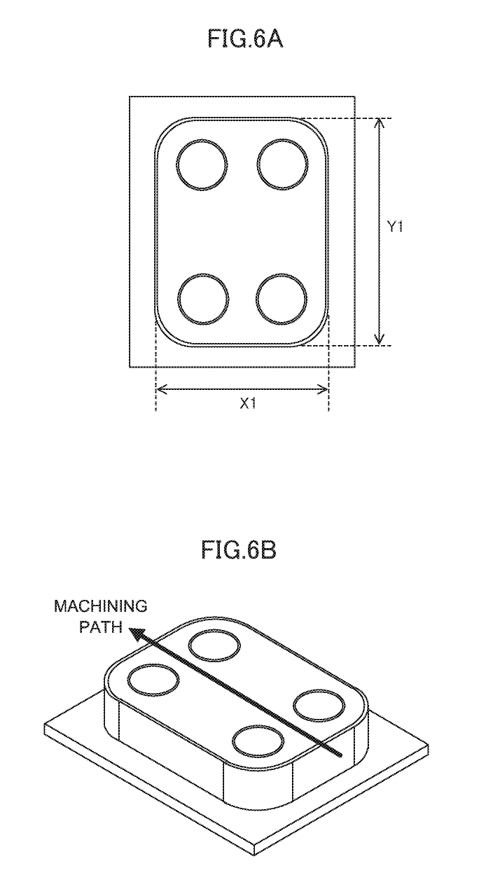

Processing for generating a machining path for deburring the workpiece shown in FIGS. 5A and 5B will be described with reference to FIGS. 6A and 6B.

In order to generate the machining path, a range in which burrs are formed is identified from a length X1 of each short side and a length Y1 of each long side of the rectangular cross-section of the workpiece shown in FIG. 6A, based on the burr data recorded in the burr data storage area. Based on the identified range, an appropriate tool is selected from the tools stored in the tool data. If the lengths X1 and Y1 are 75 mm and 120 mm, respectively, and if the tool diameters stored in the tool data are φ40, φ60 and φ80, for example, the tool with the diameter φ80 is selected, since the burrs can be efficiently machined with a tool diameter of 75 mm or more in the case of the above-described tool selection method, for example. Thus, a machining path is generated such that the tool can be longitudinally moved so as to slide on the upper surface of the unmachined workpiece 2b, as shown in FIG. 6B.

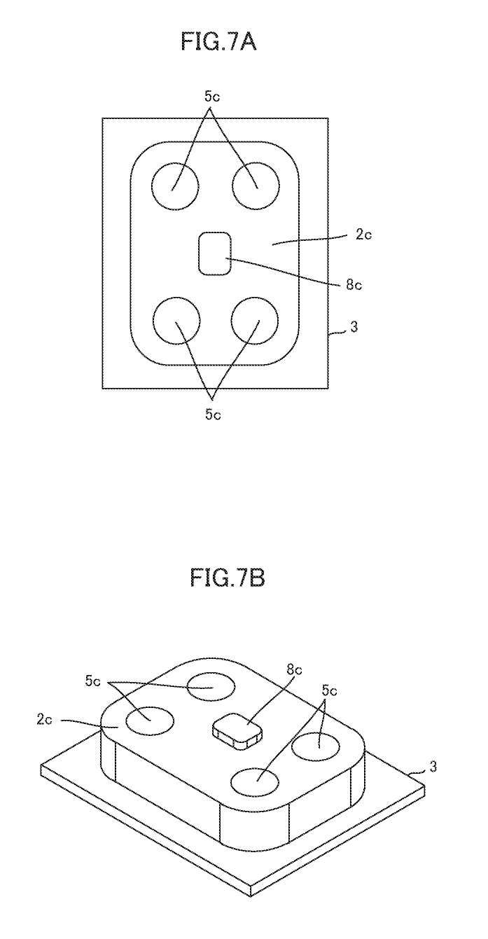

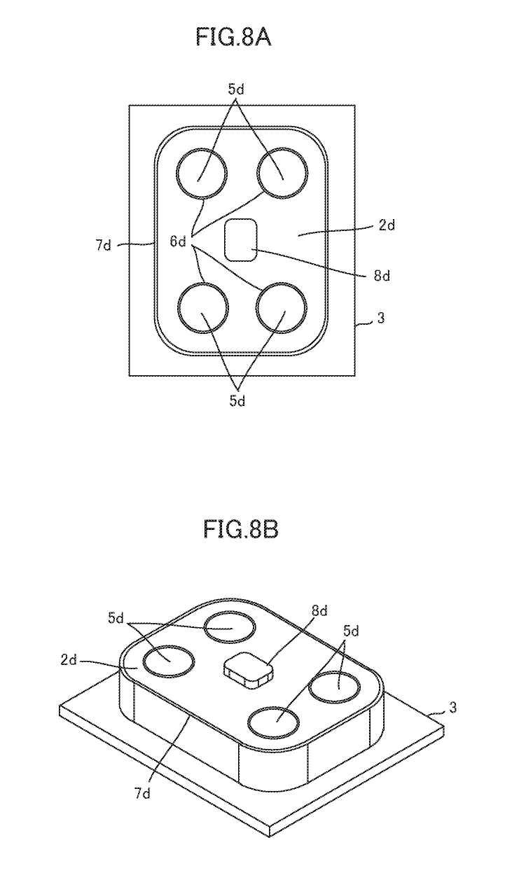

A second example of operation of the tool selection means and the machining path generation means during deburring will now be described with reference to FIGS. 7A and 7B, which show a deburred workpiece (finished workpiece), and FIGS. 8A and 8B, which show a burred workpiece (workpiece to be deburred).

In this operation example, as shown in FIGS. 7A and 7B, a structure including the finished workpiece as shown in FIGS. 4A and 4B and a protrusion 8c (obstacle) thereon is used as an object to be deburred.

FIGS. 8A and 8B show how burrs 6d and 7d are formed on the edges of an unmachined workpiece (workpiece to be deburred) 2d and the edges of holes, respectively. All these burrs 6d and 7d are assumed to extend upward as in FIG. 8B.

In deburring the unmachined workpiece 2d shown in FIGS. 8A and 8B by means of the machine tool according to the present invention, shape data on the unmachined workpiece 2d is obtained by the visual sensors (not shown). The obtained shape data and shape data on the finished workpiece 2c stored in advance in the machined workpiece shape data storage area are compared with each other, and burr data on the burrs 6d and 7d are created individually and recorded in the burr data storage area.

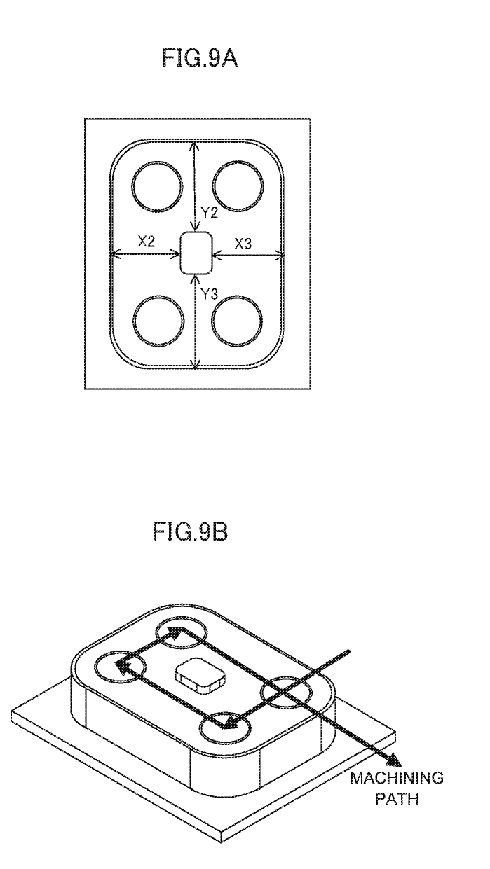

Processing for generating a machining path for deburring the workpiece shown in FIGS. 8A and 8B will be described with reference to FIGS. 9A and 9B.

The machining path is then generated so that the unmachined workpiece 2d should be deburred without interfering with a protrusion 8d. Based on the recorded burr data and the shape of the workpiece, therefore, a range in which burrs are formed is identified by calculating distances X2 and X3 from the short sides of the rectangular cross-section of the workpiece shown in FIG. 9A to the side surfaces of the protrusion and distances Y2 and Y3 from the long sides of the rectangular cross-section to the side surfaces of the protrusion. Based on the identified range, an appropriate tool is selected from the tools stored in the tool data. If both the lengths X2 and X3 are 30 mm and both the lengths Y2 and Y3 are 50 mm, and if the tool diameters stored in the tool data are φ40, φ60 and φ80, for example, the tools with the diameters φ60 and φ80 are extracted, since the burrs can be efficiently machined with a tool diameter of 60 mm or more in the case of the above-described tool selection method, for example. Among the extracted tools, the tool with the smaller diameter φ60 is selected, and a machining path is generated so as not to interfere with the protrusion 8d, as shown in FIG. 9B.

The following is a description of a specific example of deburring for the case in which the burrs 6d and 7d on the unmachined workpiece 2d shown in FIGS. 8A and 8B extend 14 mm (Z=14 mm) upward as in FIG. 8B.

If the maximum cutting depth of a tool for deburring of Z=14 mm selected by the tool selection means is 5 mm, it is necessary to perform deburring processing in the depth direction three times by the deburring tool. In this case, a machining path is generated such that the machining depths for first, second, and third cycles of deburring are 5 mm, 10 mm, and 14 mm, respectively.

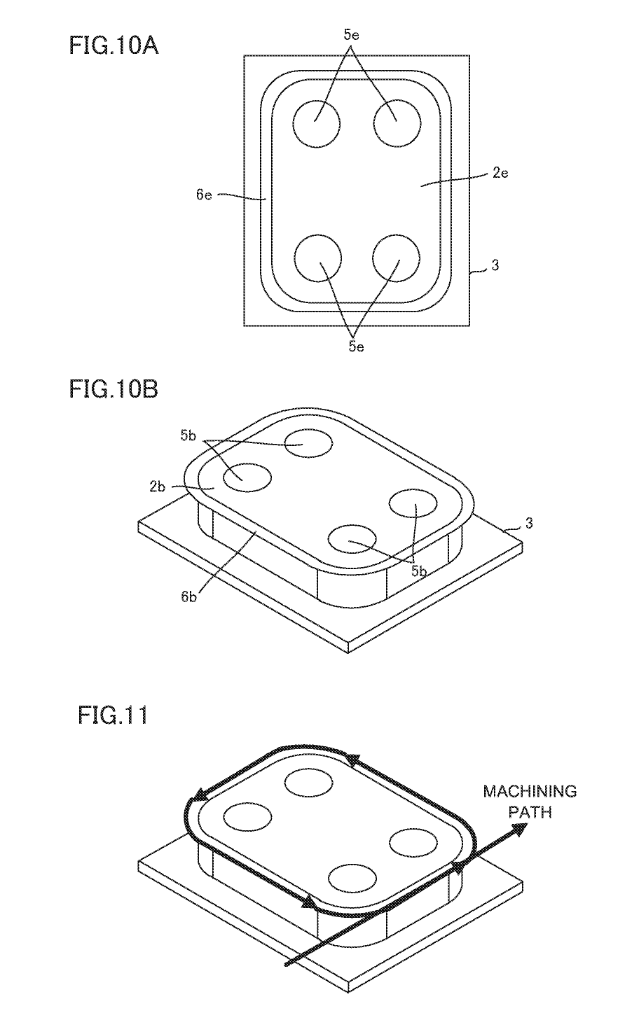

A third example of operation of the tool selection means and the machining path generation means during deburring will now be described with reference to FIGS. 10A and 10B, which show a burred workpiece (workpiece to be deburred).

As shown in FIGS. 10A and 10B, a burr 6e is formed on the edges of an unmachined workpiece (workpiece to be deburred) 2e. The burr 6e is assumed to extend vertically and horizontally as in FIG. 10A with a maximum width of 10 mm (α=10 mm).

If the maximum radial-direction cutting width of the deburring tool selected by the tool selection means is 3 mm, it is necessary to perform deburring processing in the tool radial direction four times by the deburring tool. In this case, a machining path is generated such that the machining widths for first, second, third, and fourth cycles of deburring are 3 mm, 6 mm, 9 mm, and 10 mm, respectively. This machining path is generated along the contour of the unmachined workpiece 2e, as shown in FIG. 11.

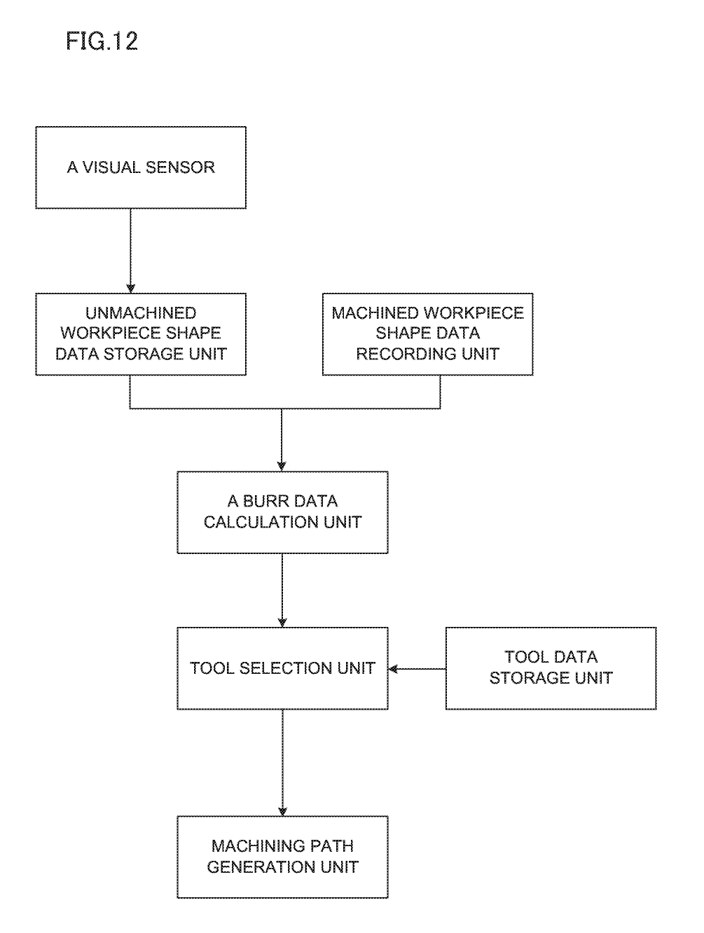

Here, components constituting a machine tool according to the present invention, which performs operations as explained above, will be described below with reference to FIG. 12.

The machine tool includes: a visual sensor 1 which captures an image of the unmachined workpiece; an unmachined workpiece shape data storage unit which stores shape data on the unmachined workpiece shot by the visual sensor 1; a machined workpiece shape data recording unit in which shape data on a machined workpiece is stored; a burr data calculation unit which compares the shape data on the machined workpiece stored in the machined workpiece shape data recording unit and the shape data on the unmachined workpiece stored in the unmachined workpiece shape data storage unit and calculate burr data including the width, depth and position of a burr; a tool data storage unit which stores the shape and cutting conditions of a tool; a tool selection unit which selects a tool to be used for deburring depending on the burr data calculated by the burr data calculation unit, based on the shape and cutting conditions of the tool stored in the tool data storage unit; and a machining path generation unit which generates a machining path along which the burr is removed based on the burr data calculated by the burr data calculation unit.

1. A machine tool for deburring a burred unmachined workpiece, comprising:
at least one visual sensor configured to capture an image of the unmachined workpiece;
an unmachined workpiece shape data storage unit configured to store shape data on the unmachined workpiece shot by the visual sensor;
a machined workpiece shape data recording unit stored with shape data on a machined workpiece;
a tool data storage unit configured to store the shape and cutting conditions of a tool;
a burr data calculation unit configured to compare the shape data on the machined workpiece stored in the machined workpiece shape data recording unit and the shape data on the unmachined workpiece stored in the unmachined workpiece shape data storage unit and calculate burr data including the width, depth and position of a burr; and
a machining path generation unit configured to generate a machining path along which the burr is removed based on the burr data calculated by the burr data calculation unit.

2. The machine tool according to claim 1, further comprising a tool selection unit configured to select a tool to be used for deburring depending on the burr data calculated by the burr data calculation unit, wherein the machining path generation unit generates the machining path by calculating the number of times of cutting for machining based on the burr data calculated by the burr data calculation unit and a maximum cutting depth in selected tool data.

3. The machine tool according to claim 1 or 2, wherein images of the workpiece are captured by the visual sensor from two or more directions.

4. The machine tool according to claim 3, comprising a plurality of the visual sensors capable of capturing the images of the workpiece from the two or more directions by individually shooting the workpiece from different directions.

5. The machine tool according to claim 3, wherein the visual sensor is mounted on a robot such that the images of the workpiece are captured from the two or more directions by changing the posture of the robot.
